(19) United States
(12) Patent Application Publication
(10) Pub. No.: US 2010/0144347 A1
(43) Pub. Date: Jun. 10, 2010

(54) WIRELESS TERMINAL DEVICE, AND CONTROL METHOD AND STORAGE MEDIUM THEREFOR

(75) Inventors: Hiroshi Yamamoto, Kawasaki (JP); Takeshi Sano, Kawasaki (JP); Kazuo Sasaki, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/618,005

(22) Filed: Nov. 13, 2009

(30) Foreign Application Priority Data
Dec. 4, 2008 (JP) 2008-309234

(51) Int. Cl. H04B 1/38; H04W 48/20

(52) U.S. Cl. 455/434; 455/574

(57) ABSTRACT

A wireless terminal device includes: a receiving section for receiving information on a distance from a range covered by a connectable access point from another wireless terminal device; a search time determination section for determining a time to start searching for the access point based on the information on the distance received by the receiving section; and a search section for sleeping until the time determined by the search time determination section, and starting to search for the connectable access point at the determined time.

### CROSS-REFERENCE TO RELATED APPLICATION

This application is based upon and claims the benefit of priority of the prior Japanese Patent Application No. 2008-309234, filed on Dec. 4, 2008, the entire contents of which are incorporated herein by reference.

### BACKGROUND

1. Field

The present invention relates to a wireless terminal device, and a control method and a control program therefor, and in particular, to a wireless terminal device which moves between access points, and a control method and a control program therefor.

2. Description of Related Art

In recent years, wireless devices have been known, to search for an access point (AP) in a wireless local area network (LAN) and, when finding a connectable access point, to connect to the access point automatically. Portable communication terminal devices (wireless terminal devices) have started to be widely used, which are equipped with such a wireless device so as to be able to access the Internet at a high speed even during movement.

However, except for access points installed by the owner oneself of the wireless terminal device, the number of access points to which the wireless terminal device can connect during movement is extremely few, and even if nationally deployed public wireless LAN services are used, areas where the wireless device can connect to the Internet are limited.

Since the power consumption of a wireless device is generally large, and a wireless terminal device is driven by a battery during movement, if the wireless device is constantly active during movement and searching for a connectable access point (hereinafter referred to as “channel scanning”), the power accumulated in the battery is consumed in a short period of time, bringing the wireless terminal device into an unusable state.

Therefore, a technique has been proposed in which a wireless terminal device present outside a communication range for an access point puts the wireless device into sleep for a fixed period of time and intermittently performs channel scanning, thereby holding back the power consumed by the wireless device.

In this case, the determination of a channel scanning interval (hereinafter referred to as a “sleeping period”) has the following trade-off.

If the sleeping period is long, the power-saving effect is high, but there is the possibility that the wireless device continues to sleep even if the wireless terminal device enters a connectable range for the access point, delaying the connection to the access point and passing by the connectable access point.

On the other hand, if the sleeping period is short, the wireless terminal device can connect to the access point immediately when entering the connectable range for the access point, but the power saving effect is low since the wireless device consumes power due to frequent channel scanning.

Consequently, for example, a technique has been proposed, which determines the sleeping period using information that allows the distance from the access point to be estimated indirectly (e.g., time since the wireless terminal device and the access point were disconnected).

Further, in another example, a technique has been known in which the wireless terminal device is provided with GPS equipment whereby an accurate distance from the connectable access point is obtained directly.

### SUMMARY

According to an embodiment, a wireless terminal device includes: a receiving section for receiving information on a distance from a range covered by a connectable access point from another wireless terminal device; a search time determination section for determining a time to start searching for the access point based on the information on the distance received by the receiving section; and a search section for sleeping until the time determined by the search time determination section, and starting to search for the connectable access point at the determined time.

It is to be understood that both the foregoing summary description and the following detailed description are explanatory as to some embodiments of the present invention, and not restrictive of the present invention as claimed.

### BRIEF DESCRIPTION OF THE DRAWINGS

FIG. 1 illustrates an overview of a wireless terminal device of an embodiment;

FIG. 2 illustrates a system of the embodiment;

FIG. 3 illustrates a hardware configuration of the wireless terminal device;

FIG. 4 is a functional block diagram of the wireless terminal device;

FIG. 5 illustrates a configuration of a probe packet;

FIG. 6 illustrates a configuration of an access point information storage section;

FIG. 7 illustrates a configuration of a sleep index management DB;

FIG. 8 illustrates the synchronization of channel scanning;

FIG. 9 illustrates the synchronization of channel scanning;

FIG. 10 is a flowchart for sleeping period determination processing;

FIG. 11 is a flowchart for the sleeping period determination processing;

FIG. 12 is a flowchart for channel scanning synchronization processing;

FIG. 13 is a flowchart for sleep index measurement processing;

FIG. 14 is a flowchart for sleep index delivery processing;

FIG. 15 is a flowchart for activation processing; and

FIG. 16 illustrates processing in the wireless terminal device.

### DETAILED DESCRIPTION OF EMBODIMENTS

An embodiment will be described in detail below with reference to the drawings.

First, an overview of a wireless terminal device of the embodiment will be described, and then, the embodiment will be described more specifically.

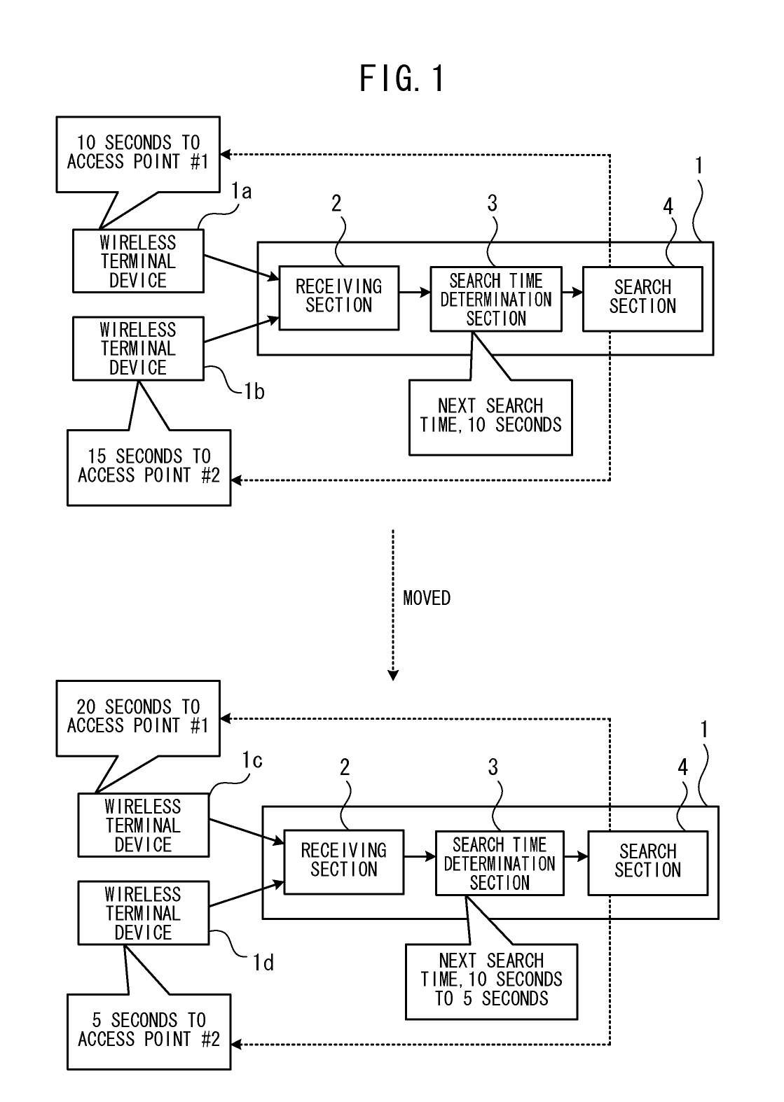

FIG. 1 illustrates an overview of the wireless terminal device of the embodiment.

A wireless terminal device 1 shown in FIG. 1 has a receiving section 2, a search time determination section 3 and a search section 4.

From other wireless terminal devices 1a to 1d, which can connect to common access points (access points #1 and #2 in FIG. 1) and were found by a search started by the search section 4, the receiving section 2 receives information on the distance from a range covered by the access points.

Here, in FIG. 1, the information on the distance is received twice at different times. The first time, information “10 seconds to the access point #1” is received from the wireless terminal device 1a found by the search started by the search section 4, and information “15 seconds to the access point #2” is received from the wireless terminal device 1b. The second time, information “20 seconds to the access point #1” is received from the wireless terminal device 1c found by the search started by the search section 4, and information “5 seconds to the access point #2” is received from the wireless terminal device 1d.

The search time determination section 3 determines a time to start searching for access points based on the information on the distance received by the receiving section 2.

The search section 4 starts searching for a connectable access point at the time determined by the search time determination section 3.

By way of example, in FIG. 1, the shorter of the time received, in other words, one by which the distance can be estimated to be closer to the access point is determined to be the time to start the next access point search. That is, the first time, from “10 seconds to the access point #1” among the information obtained, “10 seconds” is determined to be the time to start the next access point search. Then, 10 seconds later, the search section 4 performs the second search to determine, from “5 seconds to the access point #2” among the information obtained, “5 seconds” to be the time to start the next access point search.

According to this wireless terminal device 1, exchanging information on the relative distance from the access point among the wireless terminal devices in the surrounding allows the wireless terminal device 1 to obtain relatively accurate information. Then, one by which the distance can be estimated to be closer to the access point from the wireless terminal device 1 is determined to be the time to start the next access point search, and the search section 4 starts a search at that time, thereby allowing power saving and connectivity to the access point to be improved.

The embodiment will be described more specifically below.

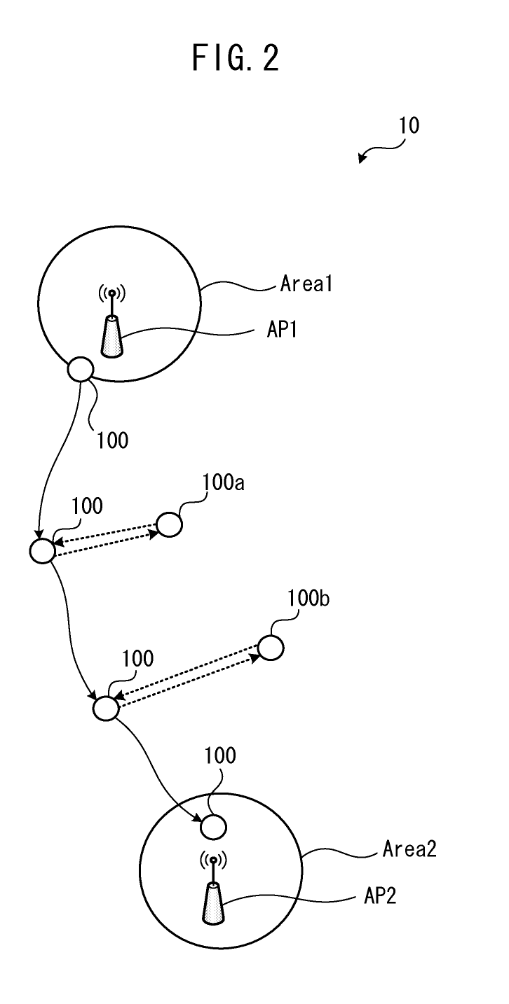

FIG. 2 illustrates a system of the embodiment.

A system 10 has a plurality of (two in FIG. 2) access points AP1 and AP2, and a plurality of (three in FIG. 2) wireless terminal devices 100, 100a and 100b.

The wireless terminal devices 100, 100a and 100b include, without limitation, a mobile phone such as a smart phone, a personal digital assistant (PDA), and a media player.

The access points AP1 and AP2 are managed by a common management unit (e.g., a public wireless LAN provider).

The access points AP1 and AP2 have areas Area1 and Area2, respectively, enabling communication of the wireless terminal devices 100, 100a and 100b.

When the wireless terminal devices 100, 100a and 100b can connect to the access point AP1 or access point AP2, respectively, the users of the wireless terminal devices 100, 100a and 100b obtain preset contents (e.g., email and RSS (Really Simple Syndication or Rich Site Summary)).

Further, when moving between the areas Area1 and Area2, the wireless terminal devices 100, 100a and 100b respectively measure information on the relative distances from the access points AP1 and AP2 (hereinafter referred to as a “sleep index”).

When detecting disconnection between a wireless device and an access point, the wireless terminal devices 100, 100a and 100b respectively start measuring the sleep index corresponding to the access point.

Then, the wireless terminal device 100, for example, at the timing of channel scanning, exchanges with the wireless terminal devices 100a and 100b in the surrounding, the information on the relative distance from the access point to which the wireless terminal devices 100a and 100b were connected before. Then, the next sleep index is determined based on the obtained sleep index and a sleep index possessed by the wireless terminal device 100 itself. Specifically, when the sleep index is large, the sleeping period is set to be long, and when the sleep index is small, the sleeping period is set to be short.

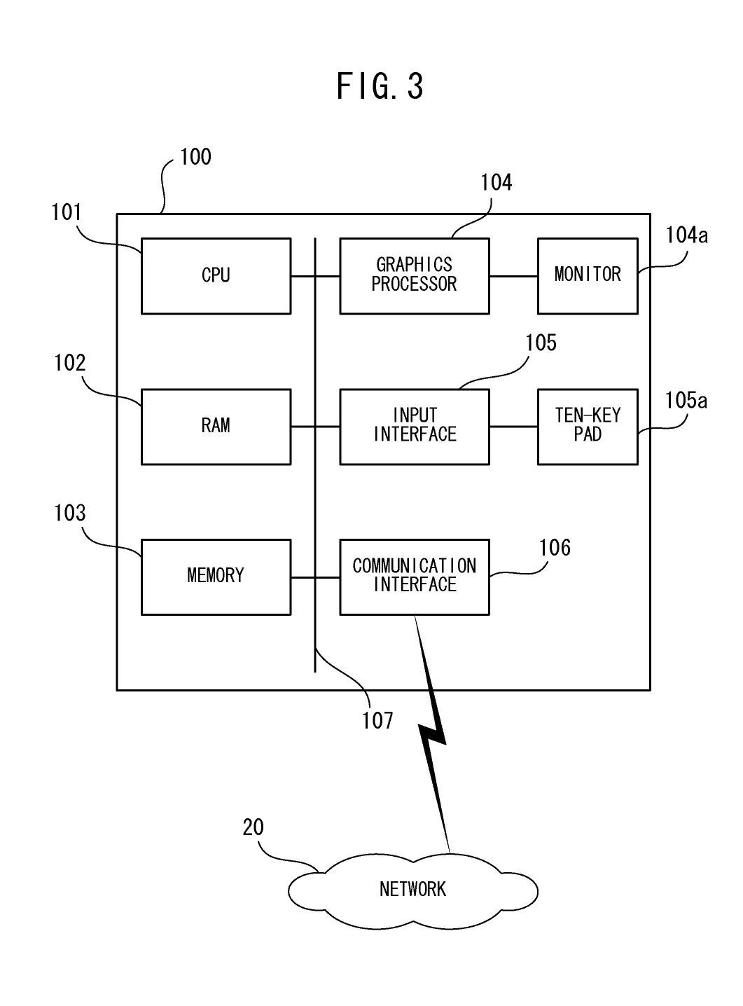

FIG. 3 illustrates a hardware configuration of the wireless terminal device.

The whole of the wireless terminal device 100 is controlled by a central processing unit (CPU) 101. A random access memory (RAM) 102, a memory 103, a graphics processor 104, an input interface 105 and a communication interface 106 are connected to the CPU 101 via a bus 107.

The RAM 102 temporarily stores at least a part of operating system (OS) programs and application programs executed by the CPU 101. The RAM 102 also stores various data necessary for processing by the CPU 101. The memory 103 stores OSs and application programs. The memory 103 also stores program files.

A monitor 104a is connected to the graphics processor 104. In accordance with an instruction from the CPU 101, the graphics processor 104 displays images on the screen of the monitor 104a. A ten-key pad 105a is connected to the input interface 105. The input interface 105 transmits signals transmitted from the ten-key pad 105a to the CPU 101 via the bus 107.

A communication interface 106 is connected to a network 20. The communication interface 106 transmits/receives data to/from other computers via the network 20.

With the above-described hardware configuration, processing functions of the embodiment can be realized. Although FIG. 3 illustrates the hardware configuration of the wireless terminal device 100, the wireless terminal devices 100a and 100b are also realized with the similar hardware configuration. To achieve power saving of the wireless terminal device 100 in a system having such a hardware configuration, the following functions are provided within the wireless terminal device 100.

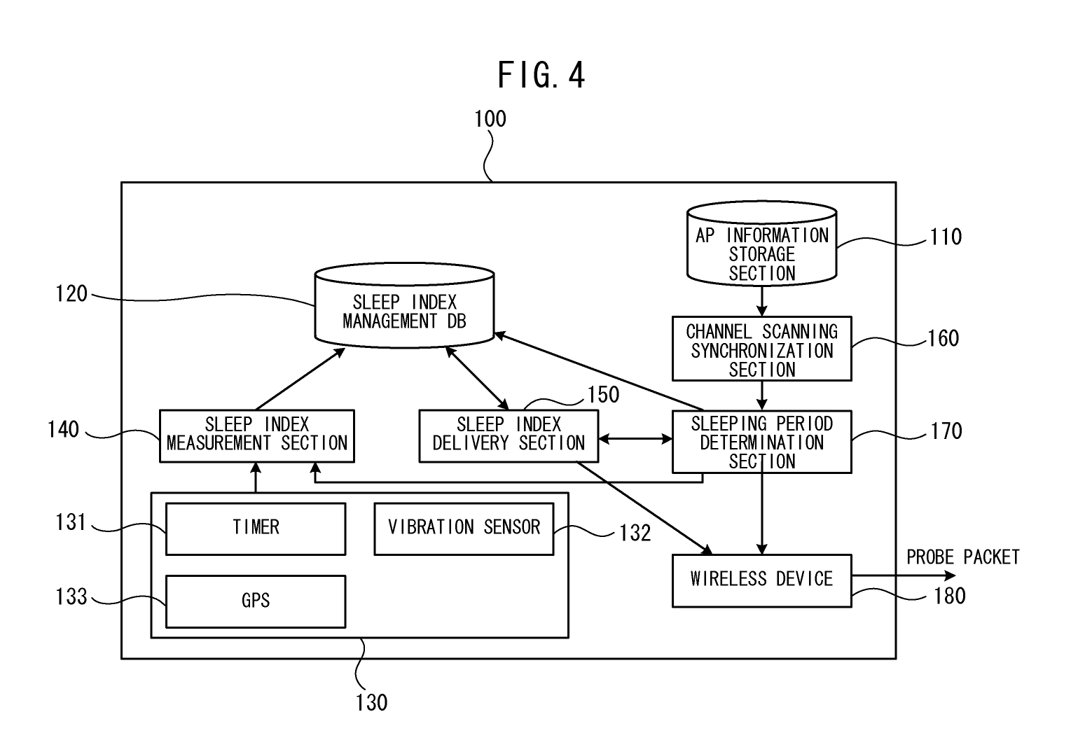

FIG. 4 is a functional block diagram of the wireless terminal device.

The wireless terminal device 100 has an access point (AP) information storage section 110, a sleep index management DB (storage unit) 120, a function group 130 for measuring sleep index, a sleep index measurement section 140, a sleep index delivery section (information update section) 150, a channel scanning synchronization section 160, a sleeping period determination section 170 and a wireless device 180.

The access point information storage section 110 stores information on the access points AP1 and AP2. The information will be described in detail later.

The sleep index management DB 120 stores information representing the relationship between a connectable access point and a sleep index.

The function group 130 for measuring sleep index has functions for measuring a sleep index.

In FIG. 4, by way of example, the function group 130 for measuring sleep index has a timer 131 for measuring the time increase since the connection with the access point was disconnected, a vibration sensor 132 for measuring vibration (for example, the number of steps of an owner), and a global positioning system (GPS) 133 for measuring the position. Arbitrary settings by the owner or a selection according to the settings of the wireless terminal device 100 are possible from these.

In this regard, these functions do not have to be newly provided, and existing functions may be used.

Based on an instruction from the sleeping period determination section 170, the sleep index measurement section 140 utilizes each function provided in the function group 130 for measuring sleep index to measure the sleep index.

For example, when the timer 131 is used, the sleep index is measured by time unit. Specifically, the time increase since the connection with the access point was disconnected is measured. Moreover, when the vibration sensor 132 is used, the sleep index is measured by unit of vibration detection. Specifically, increase in the number of vibrations detected (the number of steps) since the connection with the access point was disconnected is measured. Furthermore, when the GPS 133 is used, the sleep index is measured by the position. Specifically, increase in distance since the connection with the access point was disconnected is measured.

Further, the sleep index is measured for each identifier (ESS-ID, provider name, MAC address, etc.) identifying the access point. Then, the measured sleep index is stored in the sleep index management DB 120 for each identifier.

Based on an instruction from the sleeping period determination section 170, the sleep index delivery section 150 records the sleep index stored in the sleep index management DB 120 in a probe packet which is delivered when the wireless device 180 returns from sleep and performs channel scanning. Then, the sleep index delivery section 150 requests the wireless device 180 to deliver the probe packet to the surrounding space.

Further, when the wireless device 180 receives from a wireless terminal device in the surrounding, a sleep index for an access point that is not included in the sleep index management DB 120, the sleep index delivery section 150 adds to the information stored in the sleep index management DB 120, the sleep index for the access point. When a smaller sleep index for an access point included in the information stored in the sleep index management DB 120 is received from the wireless terminal device in the surrounding, the sleep index for the access point is updated to the received value.

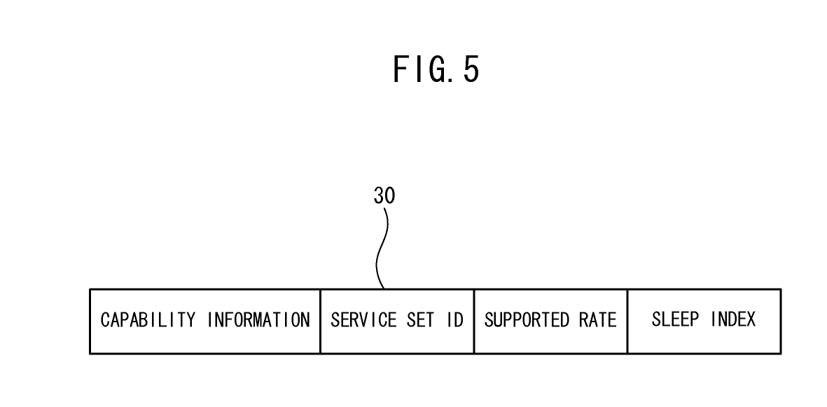

Next, a configuration of a probe packet will be described. FIG. 5 illustrates a configuration of a probe packet.

In the probe packet 30 shown in FIG. 5, Capability Information, Service Set ID and Supported Rate are fields used in a wireless LAN (802.11), followed by the sleep index.

Capability Information is various types of information such as the presence or absence of polling central control (Point Coordination Function or PCF).

Service Set ID is an identifier for an access point. When broadcast transmission is performed, Service Set ID is set to “0”.

Supported Rate is the supported rate of a wireless transmission.

Since the probe packet is a standard packet transmitted to search for an access point to which the wireless device can connect, using the probe packet for the exchange of sleep indices among the wireless terminal devices allows the sleep indices to be exchanged among the wireless terminal devices without extending the communication scheme.

Returning to FIG. 4 again, description will be made.

Based on the sleeping period determined by the sleeping period determination section 170, the channel scanning synchronization section 160 determines in advance, the timing schedule of channel scanning for each management unit of the access points AP1 and AP2.

Then, the schedule is shared among the wireless terminal devices 100, 100a and 100b to synchronize the timing of channel scanning for the wireless terminal devices 100, 100a, and 100b that can connect to the same management unit.

Specifically, for each management unit of the access points AP1 and AP2, the reference time for channel scanning is determined.

In order to realize the function of the channel scanning synchronization section 160, the timer has to be synchronized in advance among the wireless terminal devices 100, 100a and 100b; regarding the synchronization of the timer, any method (e.g., using a network time protocol (NTP), using a radio wave clock) can be selected.

The sleeping period determination section 170 instructs the sleep index delivery section 150 to start execution of channel scanning for the wireless device 180.

Then, if no presence of connectable access point—neither AP1 nor AP2—is detected in the surrounding by the channel scanning for the wireless device 180, based on the sleep index stored in the sleep index management DB 120, the sleeping period of the wireless device 180 is determined.

Specifically, for example, when the sleep index is measured by time unit, if the sleep index is 10 seconds, the sleeping period is also 10 seconds. Further, when the sleep index is measured by unit of vibration detection, if the sleep index is 10 steps, the sleeping period is the time corresponding to 10 steps (for example, about 5 seconds).

Moreover, the sleeping period is determined based on the minimum value of the sleep index in the access points AP1 and AP2 (all access points) stored in the sleep index management DB 120. This allows the connectivity to be maintained with the access point estimated to be the closest from the wireless terminal device 100.

The major portion of the search time determination section is constituted by the channel scanning synchronization section 160 and the sleeping period determination section 170.

The wireless device 180 performs channel scanning at the request of the sleep index delivery section 150, delivers the probe packet which delivery was requested by the sleep index delivery section 150, and transmits the received information to the sleep index delivery section 150.

Furthermore, when transmitting/receiving, the wireless device 180 determines whether or not a connectable access point is present based on the strength of radio waves emitted by access points, and if a connectable access point is present, connects to the access point.

In addition, when sleep is instructed by the sleeping period determination section 170, the transmission/reception functions of the wireless device 180 are stopped until a request to perform channel scanning is received from the sleep index delivery section 150 (a time to perform the next channel scanning).

The wireless device 180 constitutes the major portion of the receiving section and search section.

Next, a configuration of the access point information storage section will be described.

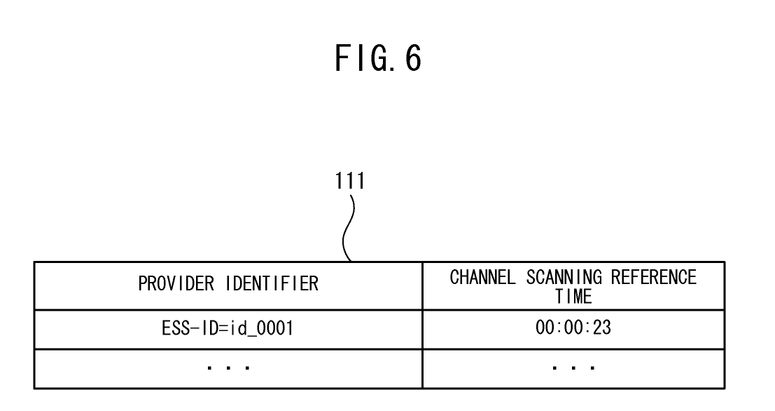

FIG. 6 illustrates a configuration of the access point information storage section.

Information is tabulated and stored in the access point information storage section 110.

An access point information management table 111 includes a provider identifier field and a channel scanning reference time field. Information arranged in the horizontal direction of each field is related to one another.

An identifier allowing the management unit of an access point to be uniquely identified is stored in the provider identifier field.

The time serving as the reference for the start of channel scanning is stored in the channel scanning reference time field.

The channel scanning reference time may be set automatically when a contract for the use of an access point is concluded with a public wireless LAN service provider, for example, or may be set manually by the owner of the wireless terminal device.

Next, a configuration of the sleep index management DB 120 will be described.

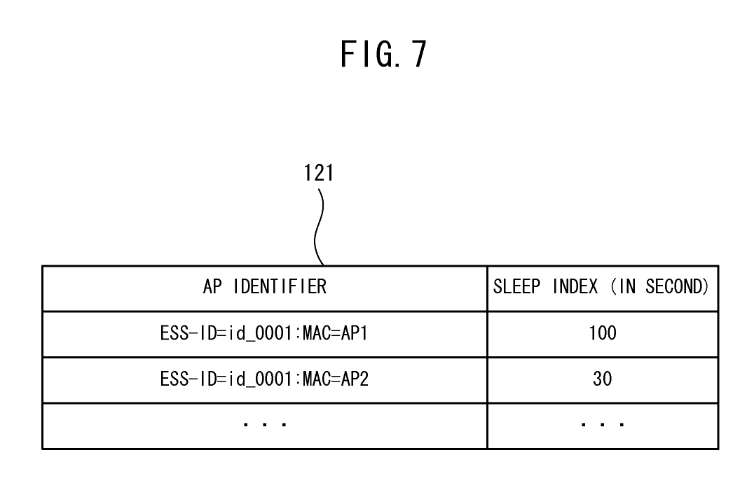

FIG. 7 illustrates a configuration of the sleep index management DB.

Information is tabulated and stored in the sleep index management DB 120.

The sleep index management table 121 includes an AP identifier field and a sleep index field (in second). Information arranged in the horizontal direction of each field is related to one another.

An identifier allowing an access point to be uniquely identified is stored in the AP identifier field.

A sleep index measured by the sleep index measurement section 140 is stored for each AP identifier in the sleep index field (in second).

In this regard, although the sleep index in the case the timer is used is stored in FIG. 7, in the case the vibration sensor is used, increase in the number of vibrations detected (the number of steps) since the connection with the access point was disconnected is stored.

Next, the operations of the channel scanning synchronization section 160 will be described.

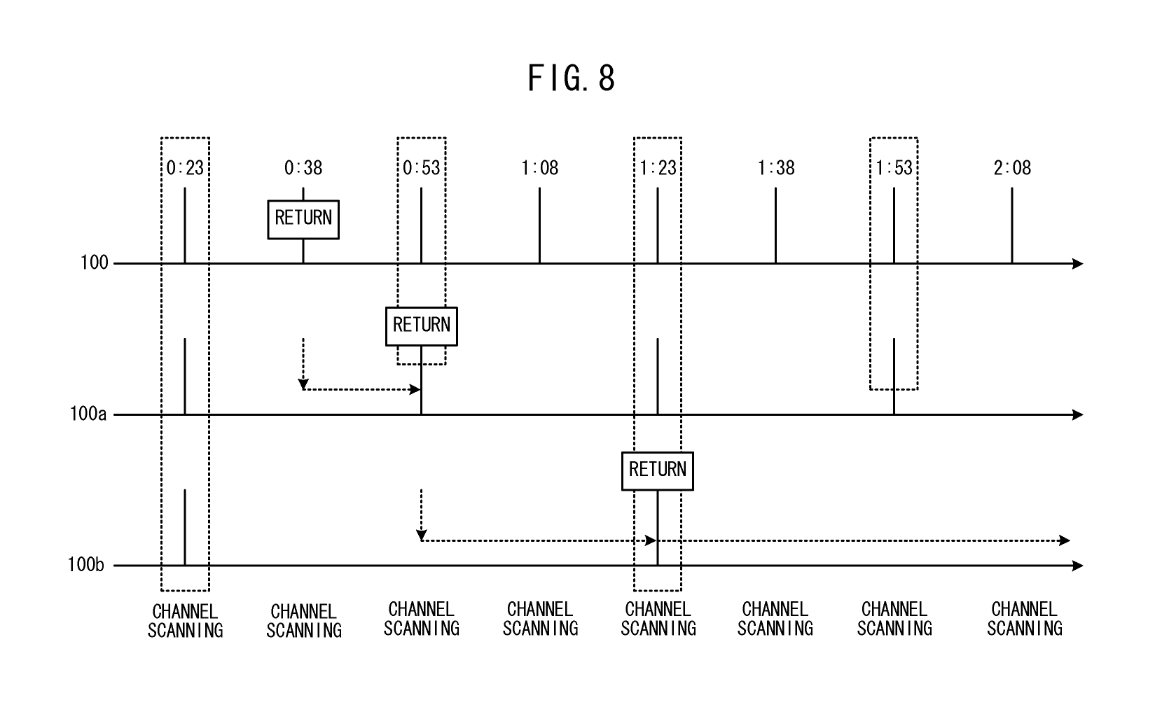

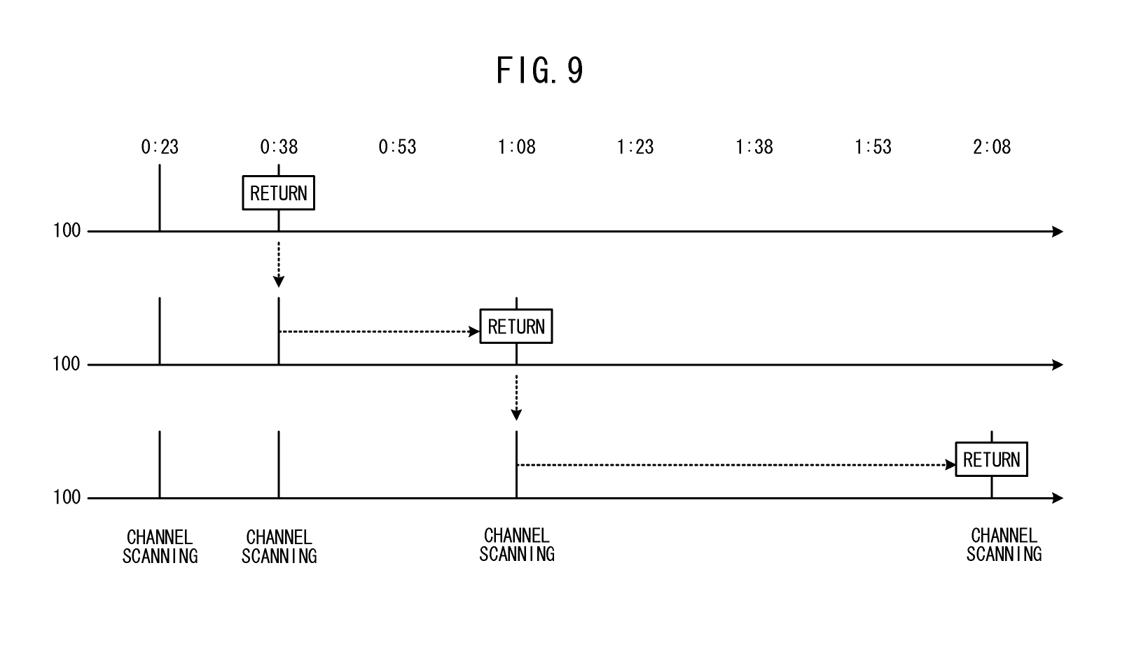

FIGS. 8 and 9 are diagrams illustrating the synchronization of channel scanning.

The wireless terminal devices 100, 100a and 100b, which can connect to the access points AP1 and AP2 having the same management unit, take as reference the same time stored in the access point information storage section provided in each of the wireless terminal devices (the access point information storage section 110 for the wireless terminal device 100) to perform channel scanning. In FIG. 8, the wireless terminal devices 100, 100a and 100b take as reference XX:00:23 to perform channel scanning.

In FIG. 8, the current sleeping period of the wireless terminal device 100 is 15 seconds, that of the wireless terminal device 100a is 30 seconds, and that of the wireless terminal device 100b is 60 seconds.

Here, if the positions of the wireless terminal devices 100, 100a and 100b do not change, these sleeping periods do not change. In this case, since the current sleeping period of the wireless terminal device 100 is 15 seconds, the wireless terminal device 100 returns from sleep, and performs channel scanning at the time of XX:00:23, XX:00:38, XX:00:53, XX:01:08, . . . .

Here, at XX:00:53, the wireless terminal device 100a also returns from sleep and performs channel scanning, therefore, the timing of the channel scanning for the wireless terminal devices 100 and 100a can be synchronized. In addition, at XX:01:23, the wireless terminal devices 100a and 100b also return from sleep and perform channel scanning, therefore, the timing of the channel scanning for the wireless terminal devices 100, 100a and 100b can be synchronized.

In this manner, even if the sleeping periods of the wireless terminal devices 100, 100a and 100b are different, returning from sleep and performing channel scanning at the same time is possible, and sleep indices can be exchanged among the wireless terminal devices 100, 100a and 100b.

Next, the transition of the sleeping period when the position of the wireless terminal device 100 changes will be described.

It is assumed that the sleeping period is a multiple of a predetermined minimum value (time interval indicator). In the case where time is used as a sleep index, for example, when the minimum value of the sleeping period is 15 seconds and the maximum value is 4 minutes, sleeping periods that can be set are 15 seconds (sleep index 0 to 29 seconds), 30 seconds (sleep index 30 to 59 seconds), . . . , 4 minutes (sleep index 4 minutes or more).

In this regard, the minimum value may be provided in the channel scanning synchronization section 160 in advance, or may be manually set by the owner of the wireless terminal device 100 and stored in the access point information storage section 110.

In FIG. 9, XX:00:23 is taken as reference to perform channel scanning. Thereafter, if the determined sleep index is 21 seconds, the sleeping period is set to 15 seconds. This causes the return from sleep to be made to perform channel scanning at XX:00:38. If the next sleep index is 33 seconds, the sleeping period is set to 30 seconds. This causes the return from sleep to be made to perform channel scanning at XX:01:08. If the next sleep index is 1 minute and 08 seconds, the sleeping period is set to 1 minute. This causes the return from sleep to be made to perform channel scanning at XX:02:08. This allows synchronization with other wireless terminal devices to be ensured readily.

Processing in the wireless terminal device 100 will be described below taking as an example a case where the wireless terminal device 100 moves between the access points AP1 and AP2.

First, the processing in the sleeping period determination section 170 when the wireless terminal device 100 leaves the communication range for the access point AP1 or AP2 (sleeping period determination processing) will be described.

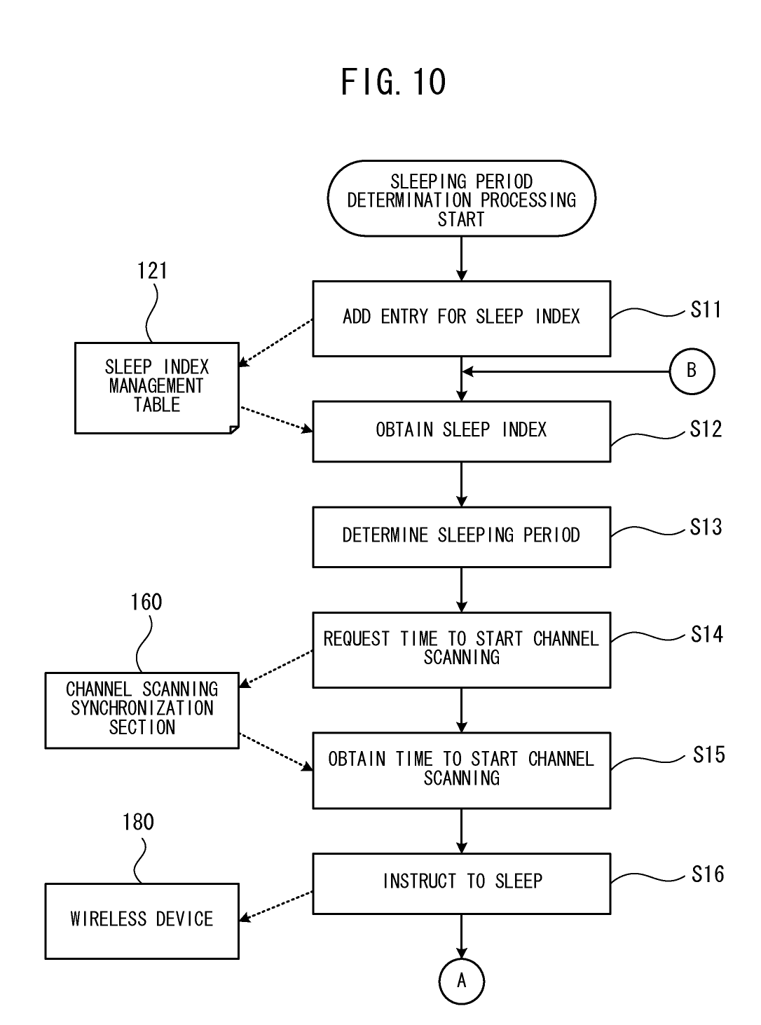

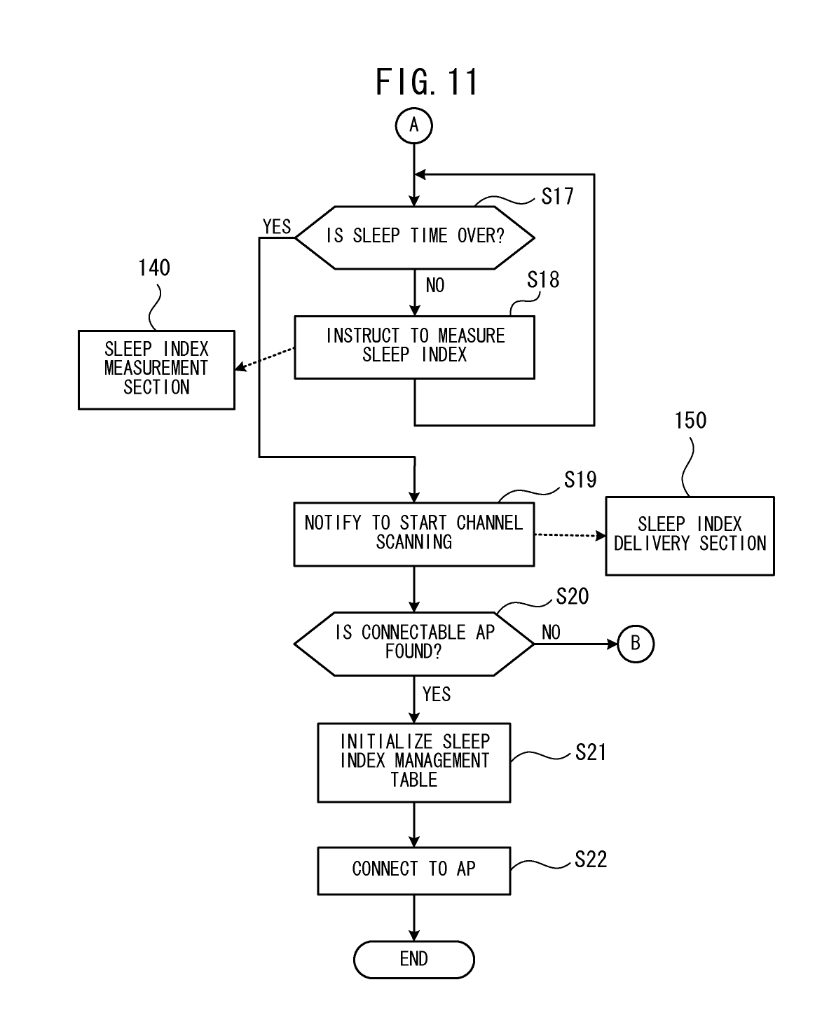

FIGS. 10 and 11 are flowcharts for sleeping period determination processing.

First, the sleeping period determination section 170 adds to the sleep index management table 121 the entry for the sleep index related to the access point that has been connected with until then (step S11). Then, the sleep index of the added entry is set to “0”.

Next, the sleeping period determination section 170 obtains the sleep index for each access point registered with the sleep index management table 121 (step S12).

Next, the sleeping period determination section 170 determines the sleeping period based on the sleep index obtained in step S12 (step S13). Specifically, the smallest value among the sleep indices for all obtained access points is selected, and the sleeping period corresponding to the value is determined. For example, when the unit of the sleep index is “second” and the minimum value of the sleep index is 30 seconds, the sleeping period is set to 30 seconds. Further, when the unit of the sleep index is “the number of steps” and the minimum value of the sleep index is 60 steps, the sleeping period is determined as 30 seconds (one second is converted to two steps).

Next, the sleeping period determination section 170 notifies the channel scanning synchronization section 160 of the sleeping period determined in step S13, and requests a time to start the next channel scanning (step S14). In this manner, the channel scanning synchronization section 160 determines the time of channel scanning synchronization.

Next, the sleeping period determination section 170 obtains the time to start the next channel scanning from the channel scanning synchronization section 160 (step S15).

Next, the sleeping period determination section 170 instructs the wireless device 180 to sleep until the time to start channel scanning obtained in step S15 (step S16).

Next, the sleeping period determination section 170 determines whether or not the sleep time is over (the time to perform channel scanning has been reached) (step S17 of FIG. 11).

If the sleep time is not over (No in step S17), the sleep index measurement section 140 is instructed to measure the sleep index (step S18). Thereafter, the processing proceeds to step S17 to continue to perform the processes from step S17 onward.

On the other hand, if the sleep time is over (Yes in step S17), the sleeping period determination section 170 notifies the sleep index delivery section 150 to start channel scanning (step S19). Thus, the sleep index delivery section 150 starts channel scanning.

Next, the sleeping period determination section 170 determines whether or not an access point to which the wireless terminal device 100 can connect was found by the channel scanning in step S19 (step S20).

If a connectable access point was found (Yes in step S20), the sleeping period determination section 170 initializes the sleep index management table 121 (step S21). Thereafter, connection to the found access point is established (step S22), and the processing ends.

On the other hand, if no connectable access point was found (No in step S20), the processing proceeds to step S12 to continue to perform the processes from step S12 onward.

Then, the description of the sleeping period determination processing ends.

Next, the processing in the channel scanning synchronization section 160 when a request for the time to start channel scanning has been notified in step S14 (channel scanning synchronization processing) will be described in detail.

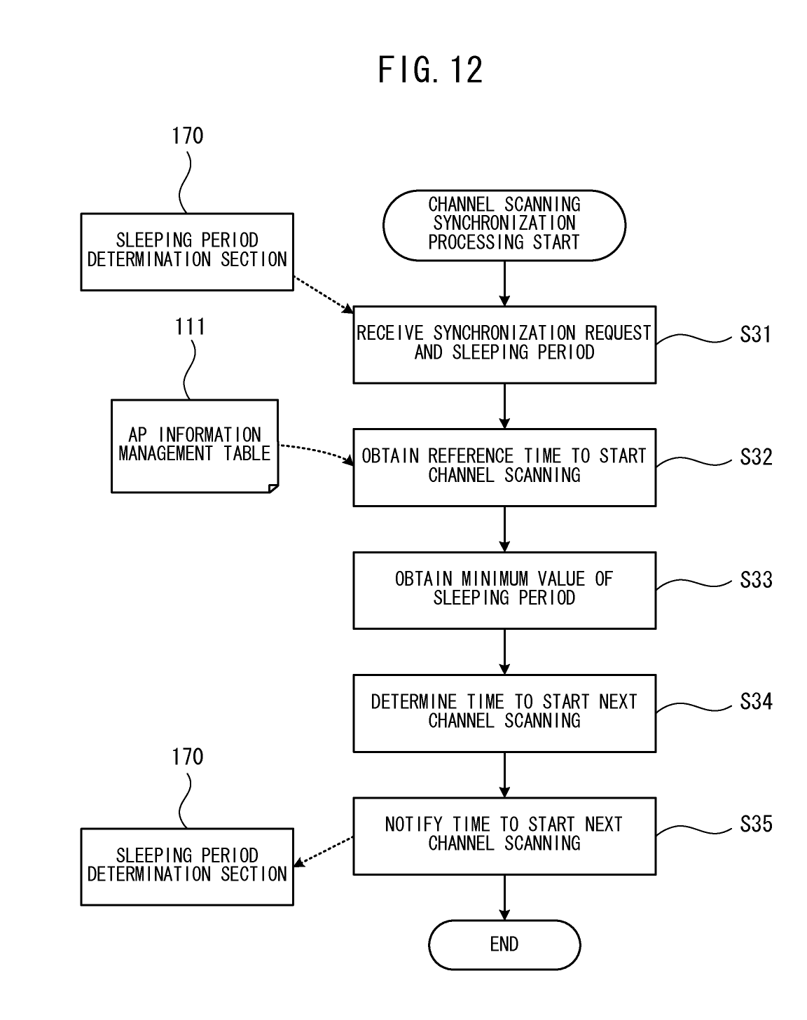

FIG. 12 is a flowchart for the channel scanning synchronization processing.

First, when a request for channel scanning synchronization together with a sleeping period are received from the sleeping period determination section 170 (step S31), the channel scanning synchronization section 160 obtains a channel scanning reference time stored in the access point information management table 111 (step S32).

Next, the channel scanning synchronization section 160 obtains the minimum value of the sleeping period (step S33).

Next, based on the channel scanning reference time obtained in step S32, the minimum value of the sleeping period obtained in step S33, and the sleeping period received from the sleeping period determination section 170, the channel scanning synchronization section 160 determines the time to start the next channel scanning (step S34). Specifically, first, among the multiples of the minimum value of the sleeping period, the maximum value not exceeding the sleeping period received from the sleeping period determination section 170 is selected, and this value is defined as the actual sleeping period. Next, the future time nearest to the current time is selected among those resulting from adding the multiples of the actual sleeping period to the reference time for channel scanning.

The time selected in this manner is transmitted to the sleeping period determination section 170 as the time to start the next channel scanning (step S35).

Then, the description of the channel scanning synchronization processing ends.

Next, the processing in the sleep index measurement section 140 when the sleep index measurement has been instructed in step S18 (sleep index measurement processing) will be described in detail.

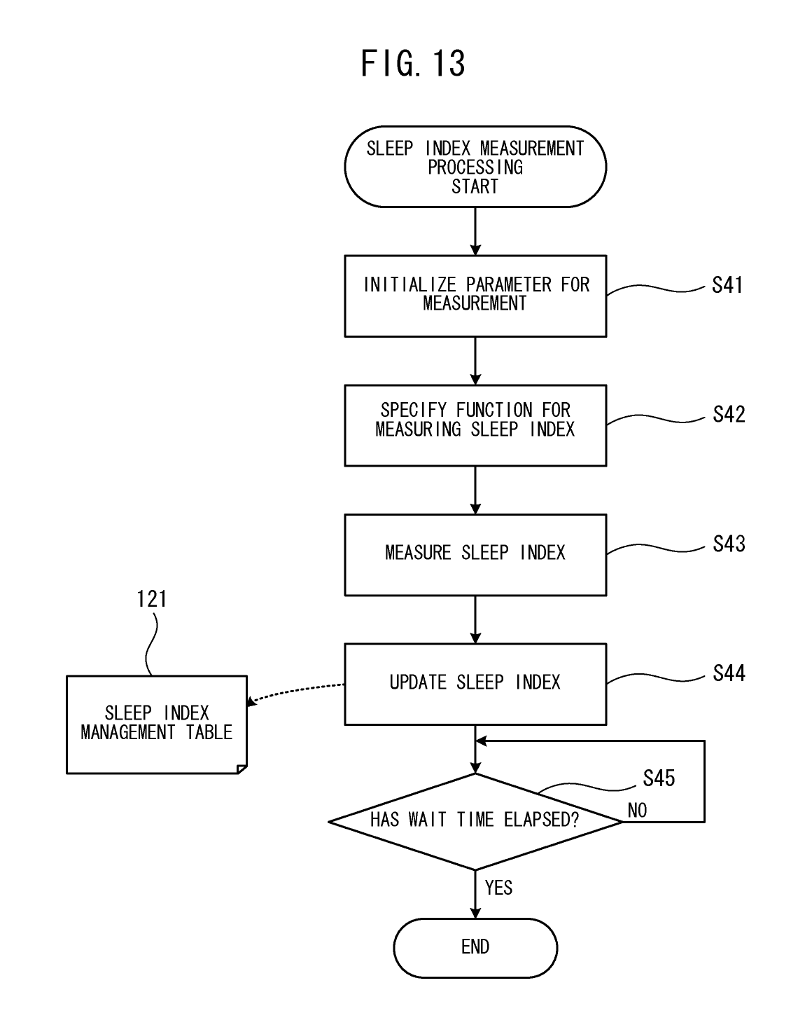

FIG. 13 is a flowchart for the sleep index measurement processing.

First, the sleep index measurement section 140 initializes various parameters used for measurement (step S41). Specifically, parameters used for measurement are initialized in this step, including a measurement period, measurement result history and the maximum value of the sleep index.

Next, the sleep index measurement section 140 specifies a function for measuring the sleep index from the function group 130 for measuring sleep index (step S42).

Next, the sleep index measurement section 140 uses the function specified in step S42 to actually measure the sleep index (step S43).

For example, when the timer 131 is selected, the measured time is recorded in the measurement result history, the difference between the time measured in the previous cycle and the time of the current cycle is calculated, and the increment of the sleep index can be determined from this difference.

In addition, when the vibration sensor 132 or GPS 133 is used, the increment of the sleeping period can be determined by calculating the difference between the result measured in the previous cycle and the result measured in the current cycle.

Next, the sleep index measurement section 140 updates the sleep index management table 121 based on the sleep index determined in step S43 (step S44). Specifically, the increment of the sleep index calculated in step S43 is added to the sleep index corresponding to each of the access points recorded in the sleep index management DB 120.

Here, in order to maintain the accuracy of the sleep index managed in the sleep index management table 121, entries for the updated sleep indices that are greater than the maximum value of the sleep index may be deleted.

Next, the sleep index measurement section 140 provides an instruction to wait to measure sleep indices for a preset measurement period (step S45). The processing waits until the wait time elapses (No in step S45), and after it has elapsed (Yes in step S45), the sleep index measurement processing ends.

However, when a unit requiring continuous measurement is used, such as the vibration sensor 132, the operation of the measurement unit is not made to sleep.

Then, the description of the sleep index measurement processing ends.

Next, the processing in the sleep index delivery section 150 when the start of channel scanning has been notified in step S19 (sleep index delivery processing) will be described in detail.

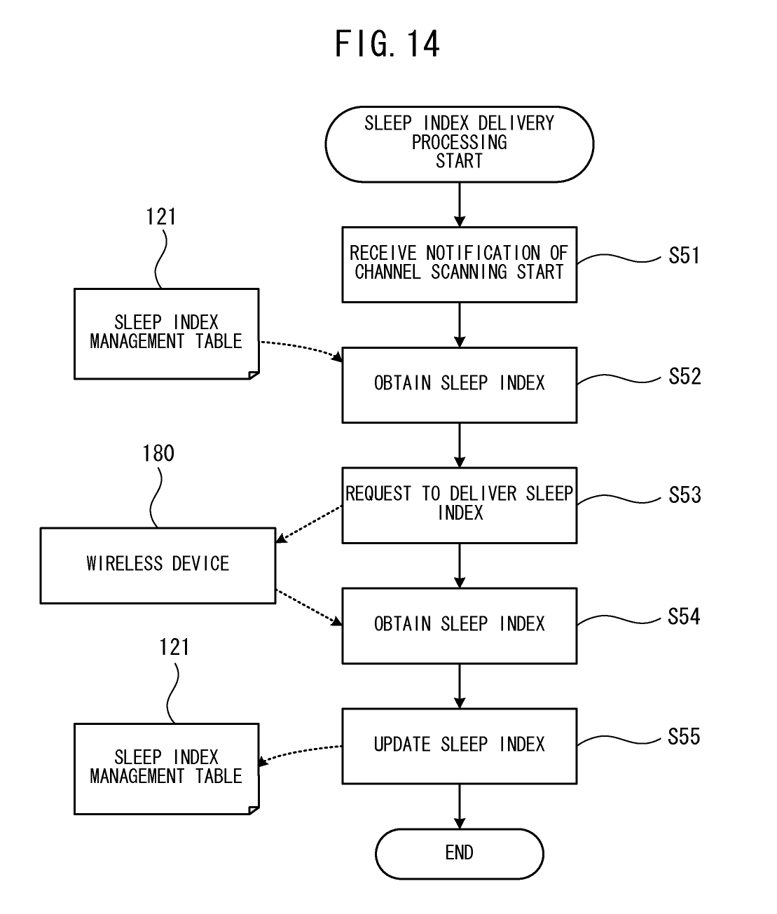

FIG. 14 is a flowchart for the sleep index delivery processing.

First, the sleep index delivery section 150 receives a notification of a channel scanning start (step S51).

Next, the sleep index delivery section 150 obtains the sleep indices for all the access points managed by the sleep index management table 121 (step S52).

Next, the sleep index delivery section 150 requests the wireless device 180 to record the sleep index obtained in step S51 in the probe packet at the time of the channel scanning and to transmit the probe packet (step S53). At that stage, if a connectable access point is present during transmission/reception, the wireless device 180 connects to the access point.

However, if the sleep index management table 121 manages no information, and no sleep index is obtained, this step may be skipped. Specifically, a request is made to perform channel scanning only, without recording the sleep index.

Next, the probe packet from the wireless terminal device in the surrounding which was received at the wireless device 180 is monitored to obtain the sleep index recorded in the probe packet (step S54).

Next, the sleep index delivery section 150 updates the contents of the sleep index management table 121 based on the sleep index obtained in step S54 (step S55). Specifically, when the sleep index related to an access point which has not been registered with the sleep index management table 121 is received, a new entry is created and registered. Furthermore, if the sleep index related to an already registered access point is received, the sleep index for the already registered entry and the sleep index received from the wireless terminal device in the surrounding are compared, and the update is made to the smaller value. The processing ends thereafter.

Then, the description of the sleep index delivery processing ends.

Next, the processing in the sleeping period determination section 170 when the wireless terminal device 100 has been activated from a state in which no power is supplied (activation processing) will be described.

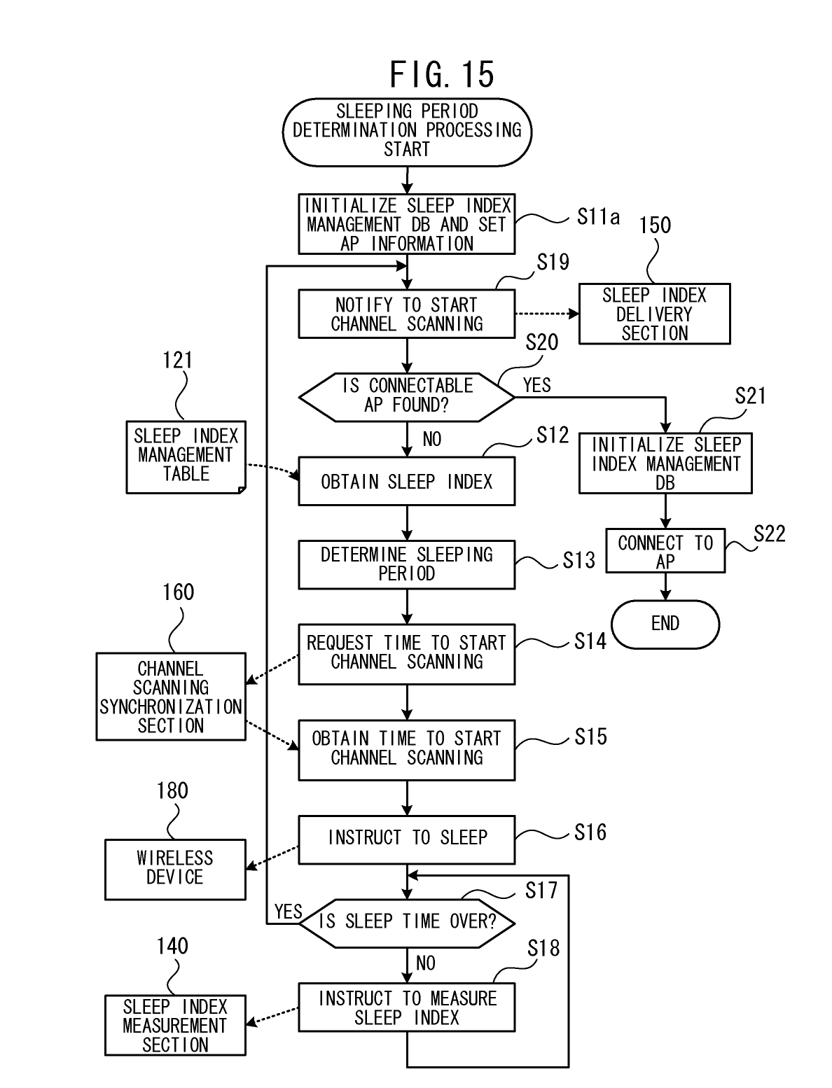

FIG. 15 is a flowchart for the activation processing.

First, the sleeping period determination section 170 initializes the sleep index management table 121, and sets the access point information management table 111 with information on access points to which the wireless terminal device 100 can connect (step S11a).

Next, the processing proceeds to step S19 to continue to perform the processes from step S19 onward. Note that since the processes of the step numbers shown in FIG. 15 and the processes of the step numbers shown in FIGS. 10 and 11 are identical, the detailed description will be omitted.

Then, the description of the processing when the wireless terminal device 100 has been activated ends.

Next, the processing in the wireless terminal device 100 described above will be described using a concrete example.

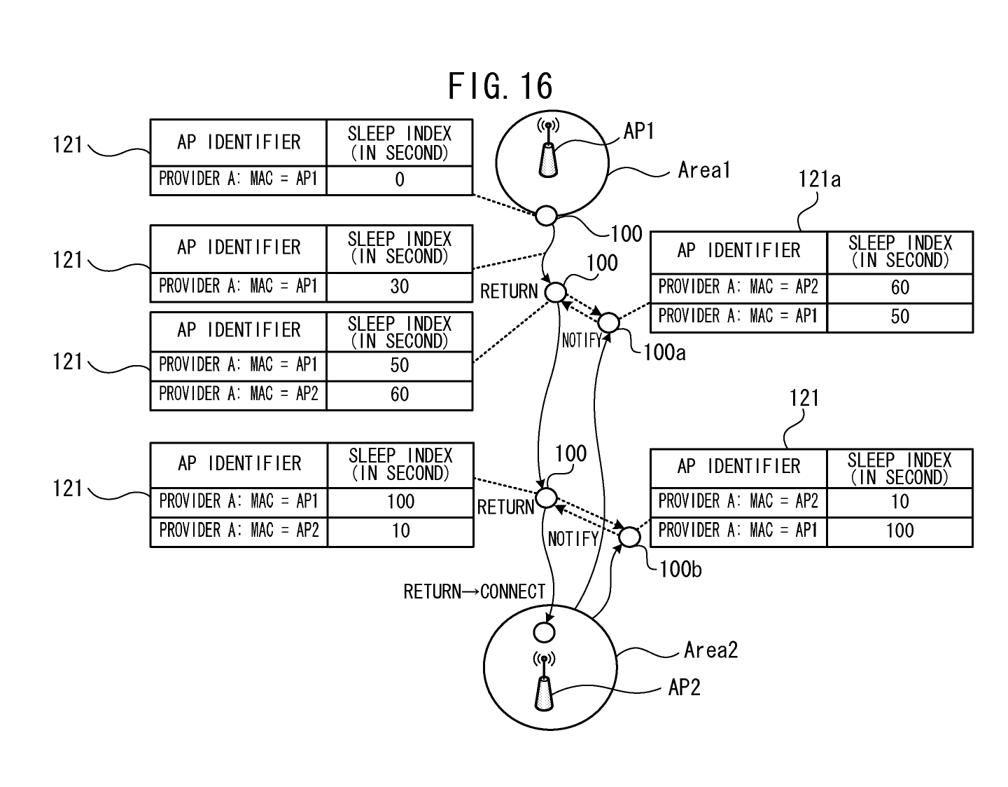

FIG. 16 illustrates the processing in the wireless terminal device.

First, when the connection with the access point AP1 is disconnected, the entry for the sleep index is added to the sleep index management table 121.

In FIG. 16, an AP identifier “provider A: MAC=AP1” is set, and the sleep index is set to 0 second.

Thereafter, the time to start channel scanning is obtained, and the wireless device 180 sleeps. While the wireless device 180 is sleeping, the sleep index measurement section 140 starts measuring the sleep index.

Thereafter, the sleep index increases along with moving.

In FIG. 16, the sleep index increases from 0 second to 30 seconds.

Thereafter, after the wireless device 180 returns from sleep, the sleep index delivery section 150 requests the wireless device 180 to deliver the sleep index. This causes the wireless device 180 to perform channel scanning and transmit/receive sleep indices, and if a sleep index is received from the wireless terminal device 100a located in the vicinity, the received sleep index is added to the sleep index management table 121.

In FIG. 16, the sleep index increases from 30 seconds to 50 seconds. In addition, 60 seconds, the sleep index for the AP identifier “provider A: MAC=AP2” in the received sleep index, is added.

Meanwhile, the wireless terminal device 100a also receives the sleep index from the wireless terminal device 100, and adds the received sleep index to the sleep index management table 121a provided in the wireless terminal device 100a.

In this manner, the wireless terminal device monitors the contents of the probe packet received by its own wireless device, allowing the sleep index to be exchanged among the wireless terminal devices.

Then, when a new sleep index is received, the minimum value is selected to update the sleep index management table 121.

In FIG. 16, the sleep index for the AP identifier “provider A: MAC=AP1” increases from 50 seconds to 100 seconds.

Further, although the sleep index for the AP identifier “provider A: MAC=AP2” in the received sleep index, also increases from 60 seconds to 110 seconds, the sleep index for the AP identifier “provider A: MAC=AP2” is updated to 10 seconds based on the sleep index newly received from the wireless terminal device 100b.

Meanwhile, the wireless terminal device 100b also receives the sleep index from the wireless terminal device 100, and adds the received sleep index to the sleep index management table 121b provided in the wireless terminal device 100b.

In this manner, by obtaining sleep indices from a plurality of wireless terminal devices, the distance from an access point can be associated with a sleep index more accurately.

As described, according to the wireless terminal device 100, information (sleep index) that can be associated with the relative distance from the access point is exchanged among wireless terminal devices in the surrounding, at the timing when the wireless device 180 returns from sleep and performs channel scanning.

Generally, due to a higher possibility that a terminal with a smaller sleep index has moved in a straight line from the access point to the point where the channel scanning was performed, the terminal with a smaller sleep index is assumed to have a sleep index that can be associated accurately with the distance to the access point. Therefore, as described above, by transmitting/receiving sleep indices among wireless terminal devices in the surrounding and updating to a smaller value at each access point, all the wireless terminal devices can manage more accurate sleep indices compared to conventional techniques.

In addition, when the sleep index is large, the sleeping period is set to be long assuming that the relative distance from the access point is long, and when the sleep index is small, the sleeping period is set to be short assuming that the relative distance from the access point is short.

In this manner, normally, the sleeping period of the wireless device is set to be long so that power saving can be maximized, and, only when there is a connectable access point at a short distance, the sleeping period is set to be short so that the connectivity with the access point can be improved.

Furthermore, since the sleep index is obtained by using standard functions provided in the wireless terminal device 100, such as the timer 131 and the vibration sensor 132, an accurate sleep index can be obtained with a simplified configuration, without the need to add new extra functions.

Moreover, since realization is possible if the space allows probe packets to be transmitted from the wireless device 180, there is almost no constraint of the location. Therefore, the determination technique of the sleeping period is not limited by locations to be used and the types of the wireless terminal device 100.

Although the wireless terminal device, and a control method and a control program therefor of the present invention have been described based on the shown embodiment, the present invention is not limited to the embodiment, and the constitution of each section may be replaced with a different constitution having a similar function. In addition, other different components and processes may be added to the present invention.

Further, the present invention may be a combination of two or more different constitutions (features) of the foregoing embodiment.

The processing functions described above can be realized by a computer. In that case, a program describing a processing content of the functions to be owned by the wireless terminal device 100 is provided. By executing the program on a computer, the above-described processing functions are realized on the computer. The program describing the processing content can be recorded on a computer-readable recording medium. Examples of the computer-readable recording medium include a magnetic recording system, an optical disc, a magneto-optical recording medium, and a semiconductor memory. Examples of the magnetic recording system include a hard disc drive (HDD), a flexible disc (FD) and a magnetic tape. Examples of the optical disc include a digital versatile disc (DVD), a digital versatile disc random access memory (DVD-RAM), a compact disc read only memory (CD-ROM), and a compact disc recordable/rewritable (CD-R/RW). Examples of the magneto-optical recording medium include a magneto-optical disk (MO).

In the case of distributing a program, portable recording media such as DVDs and CD-ROMs having recorded thereon the program are sold. Further, the program may be stored in a storage device of a server computer so as to be transferred from the server computer to another computer via a network.

A computer that executes a control program stores in its own storage device, for example, a program recorded on a portable recording medium or a program transferred from a server computer. Then, the computer reads out the program from its own storage device and executes processing according to the program. In addition, the computer may read out the program from a portable recording medium directly, and execute processing according to the program. Further, each time the program is transferred from the server computer, the computer may execute processing according to the received program sequentially.

The embodiment described above is a preferred embodiment. The present invention is not limited to this but various modifications can be made without departing from the spirit of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless terminal device comprising:
a receiving section for receiving information on a distance from a range covered by a connectable access point from another wireless terminal device;
a search time determination section for determining a time to start searching for the connectable access point based on the information on the distance received by the receiving section; and
a search section for sleeping until the time determined by the search time determination section, and starting to search for the connectable access point at the determined time.

2. The wireless terminal device according to claim 1, wherein the search time determination section further comprises a synchronization section for synchronizing with the other wireless terminal device, the timing to start searching for the connectable access point.

3. The wireless terminal device according to claim 2, wherein
the search time determination section comprises a preset time interval indicator for determining an interval of time to start searching for the connectable access point, and
the search time determination section determines the time to start searching for the connectable access point so as to be a multiple of the time interval.

4. The wireless terminal device according to claim 1, further comprising:
a storage section for having stored therein the information on the distance; and
an information update section for updating the information on the distance stored in the storage section to the information on the distance received by the receiving section that allows the distance from the range covered by the connectable access point to be determined to be closer than that of the information on the distance stored in the storage section,
wherein the search time determination section determines a time to start searching the connectable access point based on the information on the distance stored in the storage section.

5. The wireless terminal device according to claim 1, further comprising:
a measurement section for measuring information on distance from a range covered by an access point previously connected to the wireless terminal device; and
a transmission section for transmitting the information on the distance measured by the measurement section to the other wireless terminal device.

6. The wireless terminal device according to claim 5, further comprising:
a storage section for having stored therein the information on the distance received by the receiving section, and the information on the distance measured by the measurement section; and
an information update section for updating the information on the distance stored in the storage section to the information on the distance received by the receiving section that allows the distance from the range covered by the connectable access point to be determined to be closer than that of the information on the distance stored in the storage section,
wherein the search time determination section determines a time to start searching for the connectable access point based on the information on the distance stored in the storage section.

7. The wireless terminal device according to claim 5, wherein the measurement section operates when the search section is not searching for the connectable access point.

8. The wireless terminal device according to claim 5, further comprising:
a timer for measuring a time,
wherein the measurement section measures the information on the distance based on a time since the access point was disconnected.

9. The wireless terminal device according to claim 5, further comprising:
a vibration sensor for detecting vibration,
wherein the measurement section measures the information on the distance based on the number of vibrations detected by the vibration sensor since the access point was disconnected.

10. The wireless terminal device according to claim 5, wherein the transmission section uses a probe packet to transmit the information on the distance.

11. A method of controlling a wireless terminal device comprising:
receiving information on a distance from a range covered by a connectable access point from another wireless terminal device through a receiving unit of the wireless terminal device;
determining a time to start searching for the connectable access point based on the information on the distance received by the receiving unit through a search time determination unit of the wireless terminal device;
sleeping until the time determined by the search time determination unit; and
starting to search for the connectable access point at the determined time through a search unit of the wireless terminal device.

12. A non-transitory, computer-readable recording medium storing a program allowing a computer to execute:
receiving information on a distance from a range covered by a connectable access point from another wireless terminal device;
determining a time to start searching for the connectable access point based on the information on the distance;
sleeping until the determined time; and
starting to search for the connectable access point at the determined time.
